(19) United States
(12) Patent Application Publication
(10) Pub. No.: US 2022/0314693 A1
(43) Pub. Date: Oct. 6, 2022

(54) Easy Wheel Mount

(71) Applicant: Kenneth Bell, Amarillo, TX (US)

(72) Inventor: Kenneth Bell, Amarillo, TX (US)

(21) Appl. No.: 17/219,419

(22) Filed: Mar. 31, 2021

(51) Int. Cl. B60B 29/00

(52) U.S. Cl. CPC B60B 29/001

(57) ABSTRACT

A tire changing device for lifting and positioning a tire, providing rolling members allow for easy vertical adjustment of the tire and whose shape enables a tire to be conveniently rolled on, positioned and retained thereon. The tire mounting device for mounting a tire to a vehicle, includes a lower frame comprising caster wheels and raising and lowering devices which act in concert via a common control. The disclosed device also includes an upper platform in communication with the supporting pneumatic pistons and configured to be raised and lowered thereby to a height of a wheel hub to receive the tire. The device further includes a pair of rollers spaced apart an adjustable space there between less than a diameter of a wheel to be mounted to a vehicle, the pair of adjustable rollers enabling a tire rotation to align wheel hub lugs to rim lug holes.

### BACKGROUND

In order to change tires on a vehicle, the tire must be lifted off the hub once the nuts have been removed from the studs extending from the hub. Conversely, the replacement tire must be lifted back for proper positioning during mounting of the tire on the hub. Traditionally, such lifting and positioning has been done manually. However, in numerous cases the tires are too heavy and/or too unwieldy to allow for efficient and quick changing by a single person. Many people have found themselves down on the floor with the tire on their feet trying to lift it into position. Creating an uncomfortable and an inconvenient way of trying to replace a tire effectively. There have been no products available as original equipment or as an aftermarket to address this problem.

Specifically, an apparatus to simplify the process of changing a tire such as lifting and positioning the tire is not available as original equipment or as an aftermarket product to address this problem either.

Therefore, there exists a need for a device such as above, that is not being met by any known or disclosed device or system of present on the market.

### SUMMARY OF THE INVENTION

The present invention is designed to assist in mounting a tire to a vehicle. This apparatus invention is used in overcoming the above referred to difficulties in a convenient, simple and efficient manner. The tire mounting device for mounting a tire to a vehicle, includes a lower frame comprising caster wheels and raising and lowering devices which act in concert via a common control. The disclosed device also includes an upper platform in communication with the supporting pneumatic pistons and configured to be raised and lowered thereby to a height of a wheel hub to receive the tire. The device further includes a pair of rollers spaced apart an adjustable space there between less than a diameter of a wheel to be mounted to a vehicle, the pair of adjustable rollers enabling a tire rotation to align wheel hub lugs to rim lug holes.

### BRIEF DESCRIPTION OF THE DRAWINGS

FIG. 1. This is a perspective view of the Easy Wheel Mount apparatus in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

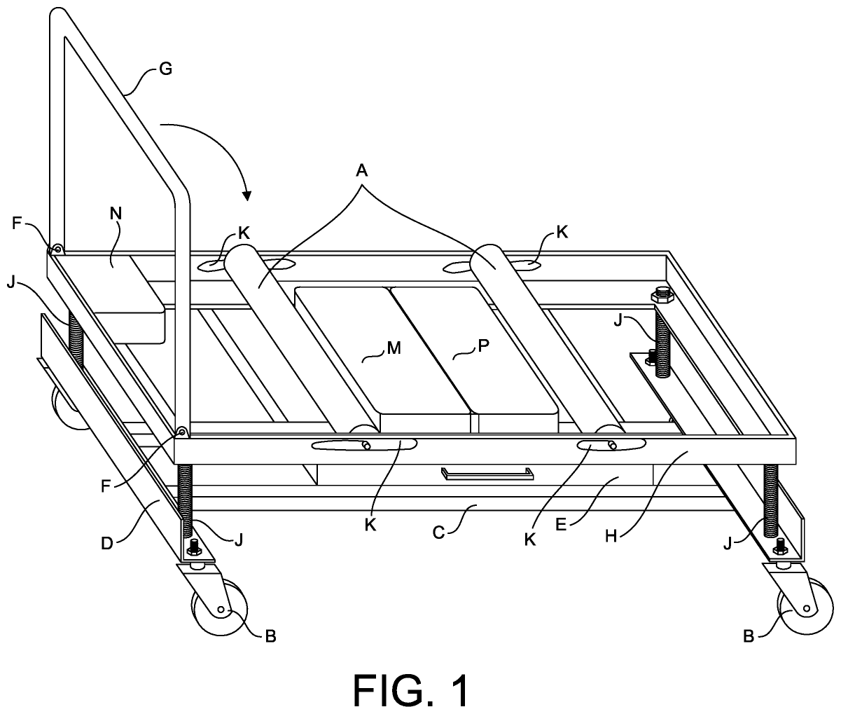

FIG. 1. This is a perspective view of the Easy Wheel Mount apparatus in accordance with an embodiment of the present disclosure. The view shows: A. Tire holder rollers, B. Caster wheels, C. Aluminum or durable plastic support, and D. Aluminum or durable plastic frame in accordance with an embodiment of the present disclosure. The view also includes the tool drawer E, the hinge or pivot F for the folding handle G, the upper platform H, the raising and lowering devices J which are springs in some embodiments, the slots K for adjusting the space between the rollers A, the motor M and the pneumatics P and the controller N for control of the mechanization of the wheel mount apparatus as claimed in an embodiment of the disclosure.

The aforementioned invention raises the tire and assists in rolling it into position with the wheel studs, thereby eliminating arduous physical strain. It is made of a sturdy, durable plastic or aluminum material with caster wheels for easy mobility and rollers to line up the wheel to the wheel studs. There is a lever underneath the platform that raises the wheel/tire for mounting.

The user simply places the tire on the platform's two rollers. The platform has springs which raise and lower the tire to align it to the studs. The user can easily move the tire with the rollers for this. Once the tire is aligned to the studs, then the user can push it onto the wheel studs and remove the platform.

The platform has springs to raise and lower the tire to the desired height making alignment of tire and studs more efficient. The rollers a user sets the tire on are also adjustable for different diameter tires.

The platform has caster wheels allowing it to be set up like a car dolly, along the outside of the platform, so that one can put longer bolts and longer springs to increase the up and down (raising and lowering) motion.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A tire mounting device for mounting a tire to a vehicle, comprising:
a lower frame comprising caster wheels and raising and lowering devices which act in concert via a common control;
an upper platform in communication with the supporting pneumatic pistons and configured to be raised and lowered thereby to a height of a wheel hub to receive the tire; and
a pair of rollers spaced apart an adjustable space there between less than a diameter of a wheel to be mounted to a vehicle, the pair of adjustable rollers enabling a tire rotation to align wheel hub lugs to rim lug holes.

2. The tire mounting device of claim 1, further comprising slots in the upper platform configured to allow lateral movement of the pair of rollers in the space apart.

3. The tire mounting device of claim 1, further comprising a pivoting handle on the upper platform, the pivoting handle configured to direct the tire mounting device under the control of a user.

4. The tire mounting device of claim 1, further comprising a tool drawer disposed on the lower frame.

5. The tire mounting device of claim 1, wherein the lower frame comprises angle iron ends and supporting lateral cross members.

6. The tire mounting device of claim 1, wherein the upper platform comprises an angle iron perimeter frame.

7. The tire mounting device of claim 1, wherein the raising and lowering devices are pneumatic pistons.

8. The tire mounting device of claim 1, wherein the raising and lowering devices are springs.

9. The tire mounting device of claim 1, wherein the raising and lowering devices are stepper motors.

10. The tire mounting device of claim 1, wherein the raising and lowing devices are mechanical bolts.

11. The tire mounting device of claim 1, further comprising notched slots in the upper platform configured to allow a lateral movement at a notch interval of the pair of rollers in the space apart.

12. The tire mounting device of claim 1, further comprising a mechanization of the castor wheels to operate under a control of the user.

13. The tire mounting device of claim 1, further comprising a mechanization of the adjustable space between the pair of rollers.

14. The tire mounting device of claim 1, wherein the common control of the raising and lowering devices comprises a common pneumatic source.

15. The tire mounting device of claim 1, wherein the common control of the raising and lowering devices comprises an electronic control of a plurality of stepper motors.

16. The tire mounting device of claim 1, wherein the common control of the raising and lowering devices comprises a common spring release for a plurality of springs as the raising and the lowering devices.

17. The tire mounting device of claim 1, wherein the common control of the raising and lowering devices comprises a bolt driver for each bolt as the raising and lowering devices, each bolt driver controlled in concert by the user.

18. The tire mounting device of claim 1, wherein the pair of rollers comprise a metal and a high tensile, high durometer plastic composite.

19. The tire mounting device of claim 1, wherein the lower frame and the upper platform comprise a metal and a high tensile, high durometer plastic composite.

20. The tire mounting device of claim 1, further comprising a mechanized turning of the pair of rollers to facilitate alignment of wheel hub lugs to rim lug holes.
